(19) United States
(12) Patent Application Publication
(10) Pub. No.: US 2026/0230489 A1
(43) Pub. Date: Aug. 6, 2026

(54) Mitigation Control Detection and Risk Reduction

(71) Applicant: ServiceNow, Inc., Santa Clara, CA (US)

(72) Inventors: Shivam Sarawagi, Hyderabad (IN); Gopi Krishna Boyinapalli, San Diego, CA (US); Venkata Satya Bharath Chadalavada, Hyderabad (IN); Venugopal Gottimukkula, Hyderabad (IN)

(21) Appl. No.: 19/036,517

(22) Filed: Jan. 24, 2025

(51) Int. Cl. H04L 9/40

(52) U.S. Cl. CPC H04L 63/1433; H04L 63/1441

(57) ABSTRACT

A method includes obtaining a plurality of security vulnerabilities for a networked device, each representing an exploitable weakness of the networked device. For a first security vulnerability, the method includes deterministically identifying a first mitigation for the first security vulnerability, determining that the first mitigation is applied to the networked device, and lowering a risk associated with the first security vulnerability. For a second security vulnerability, the method includes determining that a second mitigation for the second security vulnerability cannot be identified deterministically. Based on determining that the second mitigation cannot be identified deterministically, the method includes, identifying, using a non-deterministic model, the second mitigation, determining that the second mitigation is applied to the networked device, and lowering a risk associated with the second security vulnerability.

### TECHNICAL FIELD

This disclosure relates to mitigation control detection and risk reduction.

### BACKGROUND

Managing security vulnerabilities in networked devices is a critical task for organizations that rely on information technology for their operations. Security vulnerabilities are flaws or weaknesses in software or hardware that can be exploited by malicious actors to compromise the confidentiality, integrity, or availability of the networked devices or the data they store or process. Security vulnerabilities can expose organizations to various risks, such as data breaches, ransomware attacks, denial-of- service attacks, or unauthorized access to sensitive information.

To mitigate these risks, organizations typically employ various tools and techniques to identify, assess, and remediate security vulnerabilities. One common technique is to apply mitigation controls to the networked devices, such as firewalls, antivirus software, encryption, or patching. Mitigation controls are measures that reduce the likelihood or impact of a successful exploitation of a security vulnerability. However, applying mitigation controls to networked devices can be challenging, especially when the number and complexity of the devices and the vulnerabilities are large. Moreover, not all mitigation controls are equally effective against all types of vulnerabilities, and some vulnerabilities may require more sophisticated or customized mitigation techniques than others.

### SUMMARY

One aspect of the disclosure provides a computer-implemented method for mitigation detection and risk reduction. The method is executed by data processing hardware that causes the data processing hardware to perform operations. The method includes obtaining a plurality of security vulnerabilities for a networked device. Each security vulnerability represents an exploitable weakness of the networked device. For a first security vulnerability of the plurality of security vulnerabilities, the method includes deterministically identifying a first mitigation for the first security vulnerability. Based on identifying the first mitigation, the method includes determining that the first mitigation is applied to the networked device. Based on determining that the first mitigation is applied to the networked device, the method includes lowering a risk associated with the first security vulnerability. For a second security vulnerability of the plurality of security vulnerabilities, the method includes determining that a second mitigation for the second security vulnerability cannot be identified deterministically. Based on determining that the second mitigation cannot be identified deterministically, the method includes identifying, using a non-deterministic model, the second mitigation. The method also includes, based on identifying the second mitigation, determining that the second mitigation is applied to the networked device and, based on determining that the second mitigation is applied to the networked device, lowering a risk associated with the second security vulnerability.

Implementations of the disclosure may include one or more of the following optional features. In some implementations, the method further includes, for a third security vulnerability of the plurality of security vulnerabilities, identifying deterministically a third mitigation for the third security vulnerability. Based on identifying the third mitigation, the method may further include determining that the third mitigation is not applied to the networked device and, based on determining that the third mitigation is not applied to the networked device, maintaining or increasing a risk associated with the third security vulnerability.

In some examples, the method further includes, for a third security vulnerability of the plurality of security vulnerabilities, identifying deterministically a third mitigation for the third security vulnerability. Based on identifying the third mitigation, the method may further include determining that the third mitigation is not applied to the networked device and, based on determining that the third mitigation is not applied to the networked device, automatically applying the third mitigation to the networked device.

Optionally, the method further includes, for a third security vulnerability of the plurality of security vulnerabilities, determining that a third mitigation for the third security vulnerability cannot be identified deterministically. Based on determining that the third mitigation cannot be identified deterministically, the method may further include identifying, using the non-deterministic model, the third mitigation. Based on identifying the third mitigation, the method may further include determining that the third mitigation is not applied to the networked device and, based on determining that the third mitigation is not applied to the networked device, maintaining or increasing a risk associated with the third security vulnerability.

The method may further include, for a third security vulnerability of the plurality of security vulnerabilities, determining that a third mitigation for the third security vulnerability cannot be identified deterministically. Based on determining that the third mitigation cannot be identified deterministically, the method may further include identifying, using the non-deterministic model, the third mitigation and, based on identifying the third mitigation, determining that the third mitigation is not applied to the networked device. The method may also further include, based on determining that the third mitigation is not applied to the networked device, automatically applying the third mitigation to the networked device.

Optionally, the networked device includes one of an endpoint or a firewall. Identifying deterministically the first mitigation for the first security vulnerability may include determining that an identifier associated with the first security vulnerability is part of a signature associated with the networked device.

In some examples, the non-deterministic model includes a large language model. In some implementations, identifying, using the non-deterministic model, the second mitigation includes searching, using retrieval augmented generation, a mitigation database that indexes a plurality of potential mitigations. The method may further include filtering the plurality of security vulnerabilities based on the risk associated with each security vulnerability.

Another aspect of the disclosure provides a system for mitigation detection and risk reduction. The system includes data processing hardware and memory hardware in communication with the data processing hardware. The memory hardware stores instructions that when executed on the data processing hardware cause the data processing hardware to perform operations. The operations include obtaining a plurality of security vulnerabilities for a networked device. Each security vulnerability represents an exploitable weakness of the networked device. For a first security vulnerability of the plurality of security vulnerabilities, the operations include deterministically identifying a first mitigation for the first security vulnerability. Based on identifying the first mitigation, the operations include determining that the first mitigation is applied to the networked device. Based on determining that the first mitigation is applied to the networked device, the operations include lowering a risk associated with the first security vulnerability. For a second security vulnerability of the plurality of security vulnerabilities, the operations include determining that a second mitigation for the second security vulnerability cannot be identified deterministically. Based on determining that the second mitigation cannot be identified deterministically, the operations include identifying, using a non-deterministic model, the second mitigation. The operations also include, based on identifying the second mitigation, determining that the second mitigation is applied to the networked device and, based on determining that the second mitigation is applied to the networked device, lowering a risk associated with the second security vulnerability.

This aspect may include one or more of the following optional features. In some implementations, the operations further include, for a third security vulnerability of the plurality of security vulnerabilities, identifying deterministically a third mitigation for the third security vulnerability. Based on identifying the third mitigation, the operations may further include determining that the third mitigation is not applied to the networked device and, based on determining that the third mitigation is not applied to the networked device, maintaining or increasing a risk associated with the third security vulnerability. In some examples, the operations further include, for a third security vulnerability of the plurality of security vulnerabilities, identifying deterministically a third mitigation for the third security vulnerability. Based on identifying the third mitigation, the operations may further include determining that the third mitigation is not applied to the networked device and, based on determining that the third mitigation is not applied to the networked device, automatically applying the third mitigation to the networked device.

Optionally, the operations further include, for a third security vulnerability of the plurality of security vulnerabilities, determining that a third mitigation for the third security vulnerability cannot be identified deterministically. Based on determining that the third mitigation cannot be identified deterministically, the operations may further include identifying, using the non-deterministic model, the third mitigation. Based on identifying the third mitigation, the operations may further include determining that the third mitigation is not applied to the networked device and, based on determining that the third mitigation is not applied to the networked device, maintaining or increasing a risk associated with the third security vulnerability.

The operations may further include, for a third security vulnerability of the plurality of security vulnerabilities, determining that a third mitigation for the third security vulnerability cannot be identified deterministically. Based on determining that the third mitigation cannot be identified deterministically, the operations may further include identifying, using the non-deterministic model, the third mitigation and, based on identifying the third mitigation, determining that the third mitigation is not applied to the networked device. The operations may also further include, based on determining that the third mitigation is not applied to the networked device, automatically applying the third mitigation to the networked device.

Optionally, the networked device includes one of an endpoint or a firewall. Identifying deterministically the first mitigation for the first security vulnerability may include determining that an identifier associated with the first security vulnerability is part of a signature associated with the networked device.

In some examples, the non-deterministic model includes a large language model. In some implementations, identifying, using the non-deterministic model, the second mitigation includes searching, using retrieval augmented generation, a mitigation database that indexes a plurality of potential mitigations. The operations may further include filtering the plurality of security vulnerabilities based on the risk associated with each security vulnerability.

Another aspect of the disclosure provides a computer-readable medium having instructions that, when executed by data processing hardware, causes the data processing hardware to perform operations. The operations include obtaining a plurality of security vulnerabilities for a networked device. Each security vulnerability represents an exploitable weakness of the networked device. For a first security vulnerability of the plurality of security vulnerabilities, the operations include deterministically identifying a first mitigation for the first security vulnerability. Based on identifying the first mitigation, the operations include determining that the first mitigation is applied to the networked device. Based on determining that the first mitigation is applied to the networked device, the operations include lowering a risk associated with the first security vulnerability. For a second security vulnerability of the plurality of security vulnerabilities, the operations include determining that a second mitigation for the second security vulnerability cannot be identified deterministically. Based on determining that the second mitigation cannot be identified deterministically, the operations include identifying, using a non-deterministic model, the second mitigation. The operations also include, based on identifying the second mitigation, determining that the second mitigation is applied to the networked device and, based on determining that the second mitigation is applied to the networked device, lowering a risk associated with the second security vulnerability.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for mitigation control detection and reduction.

FIG. 2 is a schematic view of an exemplary deterministic evaluator.

FIG. 3 is a schematic view of an exemplary non-deterministic evaluator.

FIG. 4 is a flowchart of an example arrangement of operations for a method for mitigation control detection and reduction.

FIG. 5 is a schematic view of an example computing device that may be used to implement the systems and methods described herein.

Like reference symbols in the various drawings indicate like elements.

### DETAILED DESCRIPTION

The field of vulnerability management involves identifying, assessing, and resolving security vulnerabilities in networked devices. These vulnerabilities represent exploitable weaknesses that can be exploited by malicious actors to compromise the networked devices or the network as a whole. Vulnerability management is a vital component of maintaining a secure and reliable network, as well as complying with various regulations and standards. However, existing methods and systems for vulnerability management face several challenges that limit their performance and effectiveness.

For example, conventional methods for mapping vulnerabilities to mitigation techniques often rely on deterministic or rule-based approaches. These approaches use predefined logic or criteria to correlate vulnerabilities with mitigation controls, such as firewalls, endpoint protections, or patches. However, these approaches may not be able to handle complex or dynamic scenarios, where the vulnerabilities or the mitigation techniques are not well-defined or easily identifiable. Moreover, these approaches may not account for the effectiveness or availability of the mitigation controls, leading to inaccurate or incomplete mappings.

Another challenge is the prioritization of tickets created in a vulnerability response product. These tickets, which generally represent notifications of vulnerabilities, are generated by the vulnerability response product. Large networks can easily generate thousands of tickets, if not more. These tickets represent the tasks or actions required to resolve the vulnerabilities identified on the networked devices. However, conventional methods for prioritizing these tickets may not consider the actual risk posed by the vulnerabilities or the impact of the mitigation controls on reducing the risk. This may result in inefficient or ineffective allocation of resources and attention to the most critical vulnerabilities.

Implementations herein provide a solution for vulnerability management that overcomes these challenges. The implementations may utilize generative AI to assist in mapping vulnerabilities to mitigation techniques when deterministic methods are insufficient. The implementations reduce the risk score of vulnerabilities mitigated by existing controls, thereby enhancing the prioritization of tickets created in a vulnerability response system, such as an IT system or dashboard. In some examples, the implementations may automatically apply identified mitigations to networked devices, thus improving the security of the device without manual intervention.

In some implementations, a risk controller obtains a plurality of security vulnerabilities for a networked device, where each security vulnerability of the plurality of security vulnerabilities represents an exploitable weakness of the networked device. The risk controller identifies deterministically a first mitigation for a first security vulnerability and, based on identifying the first mitigation, determines that the first mitigation is applied to the networked device. Based on determining that the first mitigation is applied to the networked device, the risk controller lowers a risk associated with the first security vulnerability. For a second security vulnerability, the risk controller determines that a second mitigation for the second security vulnerability cannot be identified deterministically. Based on determining that the second mitigation cannot be identified deterministically, the risk controller identifies, using a non-deterministic model, the second mitigation. Based on identifying the second mitigation, the risk controller determines that the second mitigation is applied to the networked device and lowers a risk associated with the second security vulnerability.

The risk controller leverages a non-deterministic model (e.g., a large language model) to assist in mapping vulnerabilities to mitigation techniques when deterministic methods are insufficient. Generative AI is a branch of AI that analyzes and synthesizes information from various sources, such as databases, frameworks, or models, to provide context-aware responses or solutions. In the context of the implementations herein, generative AI may integrate information from external databases (e.g., the MITRE ATT&CK framework and the National Vulnerability Database (NVD)) to map vulnerabilities to mitigation techniques. The model may include a generative AI model to query the external databases (or a local copy of the external databases) and pass the summary and/or mitigations associated with the vulnerability to the model. The model then returns a technique that can exploit the vulnerability and map the technique to the vulnerability. The risk controller may determine whether the networked device has existing mitigation controls that can protect against the technique and reduce the risk score accordingly and/or apply the mitigation automatically.

Advantageously, this enhances the prioritization of tickets created in a vulnerability response system by reducing the risk score of vulnerabilities that are mitigated by existing controls. When the networked device has existing mitigation controls, such as firewalls or endpoint protections, that can protect against the vulnerabilities, the risk can safely be reduced and the associated ticket deprioritized. The amount that the risk is reduced may be based on the effectiveness of the mitigation control. This allows the vulnerability response system to focus resources on the most critical vulnerabilities, reducing risk and improving overall security posture.

These implementations offer advantages over existing methods and systems for vulnerability management. For example, the implementations may automate the process of mapping vulnerabilities to mitigation techniques, reducing manual work and resource wastage. Additionally, the accuracy and relevance of the mappings, by utilizing generative AI and comprehensive databases to provide context-aware responses, is enhanced. Moreover, the implementations described herein improve the efficiency and prioritization of vulnerability management by focusing resources on the most critical vulnerabilities and reducing the risk score of mitigated vulnerabilities.

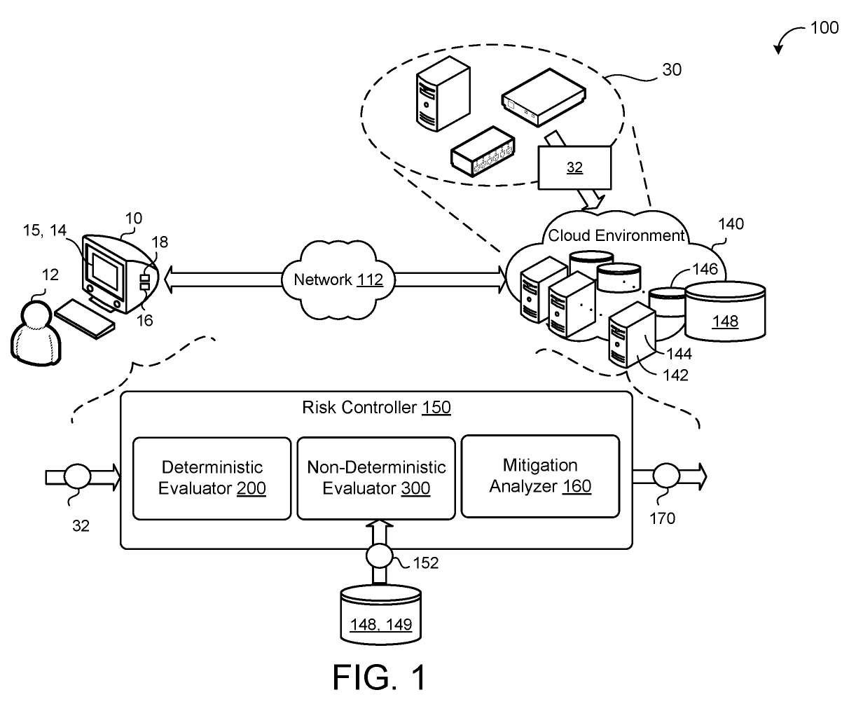

Referring to FIG. 1, in some implementations, a risk evaluation system 100 evaluates and mitigates security vulnerabilities 32. The system 100 may include a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 15 for display on a screen 14 in communication with the data processing hardware 18.

In some implementations, the remote system 140 executes a risk controller 150 that the user device 10 communicates with via the network 112. The risk controller 150 is a software application or module that is configured to identify, evaluate, and apply/adjust risk scores 170 and/or apply mitigations 152 to security vulnerabilities 32 identified on devices 30. Examples of devices 30 that may have security vulnerabilities 32 include endpoints (e.g., mobile devices, desktop computers, virtual machines, etc. ), firewalls, servers, and Internet of Things (IoT) devices. Security vulnerabilities 32 can manifest in various forms, such as exploitable weaknesses in software, misconfigurations, or outdated firmware. For instance, an endpoint device 30 might have a vulnerability 32 due to an unpatched operating system, while a firewall could be susceptible to misconfiguration that allows unauthorized access. These networked devices 30 often face vulnerabilities 32 due to weak authentication mechanisms. These vulnerabilities 32 are often mitigated by applying appropriate mitigations 152, such as patching software, reconfiguring settings, and/or enhancing authentication protocols.

The risk controller 150 may be implemented on the user device 10, the remote system 140, or a combination thereof. The risk controller 150 may interact with other software applications or modules that provide the GUI 15 or the devices 30, such as a web browser, a web server, a web application, a native application, or a hybrid application. The risk controller 150 receives a plurality of security vulnerabilities 32 for a networked device 30, each security vulnerability 32 representing an exploitable weakness of the networked device 30. The risk controller 150 includes a deterministic evaluator 200 and a non-deterministic evaluator 300 that are configured to identify mitigations 152 for the security vulnerabilities 32. Based on identifying the mitigations 152, the risk controller 150 may adjust a risk 170 (which may also be referred to as a risk level, risk score, threat, threat level, threat score, etc.) of the security vulnerabilities 32 and/or automatically apply the mitigations 152 to the security vulnerabilities 32. The amount that the risk 170 is adjusted may be based on a severity of the security vulnerability 32 and/or an impact or effectiveness of the corresponding mitigation(s) 152. For example, when the effectiveness of the mapped mitigation is high, the risk controller 150 may adjust the risk 170 to low, while when the effectiveness of the mapped mitigation is less effective, the risk controller may adjust the risk 170 to medium.

Conventional systems generally apply a default risk level 170 to each security vulnerability 32. For example, a vulnerability response system that generates tickets in response to discovered vulnerabilities 32 assigns a default risk level 170 to each security vulnerability 32 based on the type of vulnerability 32 or other predetermined metrics. However, some systems can generate a very large number of tickets or incidents based on the number of devices 30 in the system and the corresponding security vulnerabilities 32. In this scenario, prioritizing the tickets is a challenge. The risk controller 150, in response to determining that the identified mitigation 152 is applied to the security vulnerability 32 (either previously or by the risk controller 150), may reduce the risk level 170 of the security vulnerabilities 32. This allows for better prioritization and management of the security vulnerabilities 32.

The risk controller 150, in some examples, includes a deterministic evaluator 200 and a non-deterministic evaluator 300. The deterministic evaluator 200 uses deterministic means (e.g., predefined rules and logic) to identify mitigations 152 for known security vulnerabilities 32. In contrast, the non-deterministic evaluator 300 leverages non-deterministic means (e.g., machine learning models) to identify potential mitigations 152 for unknown or complex vulnerabilities 32. For example, consider a scenario where a networked device 30 has multiple security vulnerabilities 32. The deterministic evaluator 200 identifies a first mitigation 152 for a first vulnerability 32 by matching the first mitigation 152 with the first vulnerability 32 using predefined rules. The risk controller may then reduce a risk level 170 associated with the first vulnerability 32 and/or apply the first mitigation 152 to the device 30, thereby automatically reducing the associated risk 170. However, in this example, the deterministic evaluator 200 fails to identify a suitable mitigation 152 for a second, more complex vulnerability 32. In this case, the risk controller 150 may rely on the non-deterministic evaluator 300 to use a different technique, such as a machine learning model 310, to analyze the second vulnerability 32 and identify a second mitigation 152. Similarly, the risk controller 150 may reduce a risk level 170 associated with the second mitigation 152 and/or apply the second mitigation 152 to the device 30, thereby automatically lowering the risk 170 associated with the second vulnerability 32.

In some implementations, the risk controller 150 executes a mitigation analyzer 160. The mitigation analyzer 160 receives the security vulnerability 32 and the corresponding mitigation 152 matched by the deterministic evaluator 200 or the non- deterministic evaluator 300. The mitigation analyzer 160 may determine whether the mitigation 152 is applied to the security vulnerability 32 and/or the device 30. For example, the mitigation analyzer 160 queries or scans the device 30, evaluates a log generated by the device 30 or a third-party service, etc. Based on determining whether the mitigation 152 is applied to the security vulnerability 32 and/or the device 30, the mitigation analyzer 160 may perform one or more actions. Alternatively, the mitigation analyzer 160 may recommend one or more actions (e.g., to the risk controller 150, the user 12, etc.). The actions, in some implementations, includes one or more of: maintaining the risk 170 associated with the security vulnerability 32 (e.g., when the mitigation 152 is not applied), increasing the risk 170 associated with the security vulnerability 32 (e.g., when the mitigation 152 is not applied), decreasing the risk 170 associated with the security vulnerability 32 (e.g., when the mitigation 152 is applied), automatically applying the mitigation 152.

In some implementations, the risk controller 150 may adjust the risk 170 associated with a security vulnerability 32 by modifying a ticket or report that is generated in response to the detection of the security vulnerability 32. The ticket or report may include information about the security vulnerability 32, such as its identifier, its summary, its CWE, its source, its target, its exploitability, its impact, its remediation, and its risk 170. The ticket or report may also include information about the mitigation 152, such as its identifier, its description, its effectiveness, its availability, and its status. The risk controller 150 may modify the ticket or report by updating the risk 170 and/or the status of the mitigation 152 based on the identification and/or application of the mitigation 152. The risk controller 150 may store the modified ticket or report in the data store 148 or in another storage device accessible by the risk controller 150.

In some implementations, the user 12 may receive and review the modified tickets or reports via the GUI 15 that is provided by the risk controller 150 or by another software application or system in communication with the risk controller 150. The GUI 15 may display the tickets or reports in a list, a table, a chart, a dashboard, or any other suitable format. The GUI 15 may allow the user 12 to filter or sort the tickets or reports based on various criteria (i.e., filter the security vulnerabilities 32), such as the risk 170, the status, the type, the source, the target, the date, or the priority of the security vulnerability 32 and/or the mitigation 152. The GUI 15 may also allow the user 12 to view the details of a selected ticket or report, such as the information about the security vulnerability 32 and the mitigation 152. The GUI 15 may facilitate the user's 12 decision making and action taking regarding the security vulnerabilities 32 and the mitigations 152.

In some implementations, the risk controller 150 may apply mitigations 152 automatically or generate notifications to the user 12 asking the user 12 whether the mitigations 152 should be applied. The risk controller 150 may apply mitigations 152 automatically based on predefined or dynamic rules, policies, preferences, or thresholds that determine when and how the mitigations 152 should be applied. For example, the risk controller 150 may apply a mitigation 152 automatically if the risk 170 associated with the security vulnerability 32 is above a certain level, if the mitigation 152 is highly effective and available, or if the user 12 has previously authorized the automatic application of the mitigation 152. Alternatively, or additionally, the risk controller 150 may generate notifications to the user 12 asking the user 12 whether the mitigations 152 should be applied. The notifications may be sent to the user 12 via the GUI 15, an email, a text message, a phone call, or any other suitable communication channel. The notifications may include information about the security vulnerability 32, the mitigation 152, and the risk 170, and may prompt the user 12 to confirm, reject, or defer the application of the mitigation 152. The notifications may enable the user 12 to exercise control and oversight over the mitigations 152.

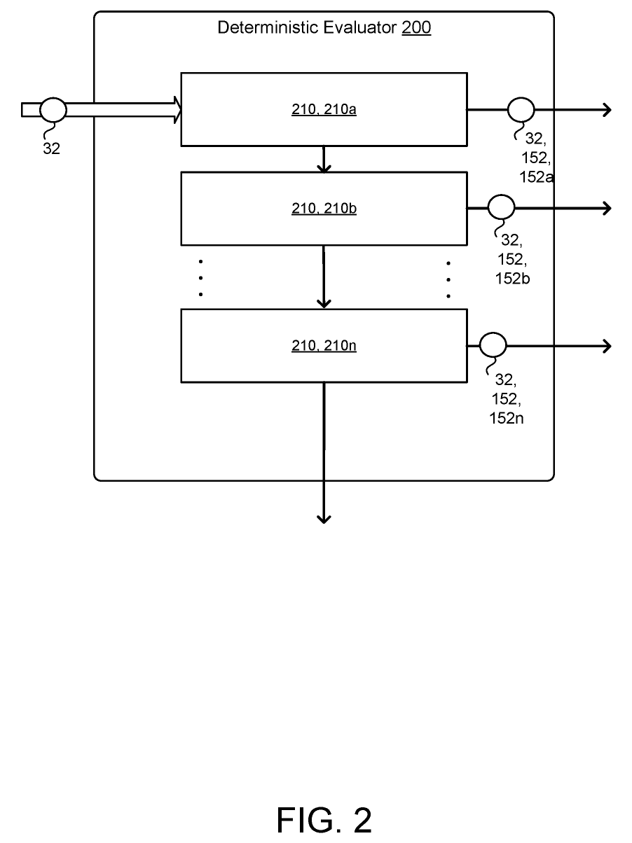

Referring now to FIG. 2, the deterministic evaluator 200 of the risk controller 150. The deterministic evaluator 200 is configured to identify a mitigation 152 for a security vulnerability 32 using a deterministic approach. The deterministic approach may include evaluating one or more rules 210, 210a-n. Each rule may evaluate whether a particular security vulnerability 32 maps to a particular mitigation 152. For example, when receiving a security vulnerability 32, the deterministic evaluator 200 determines, based on a first rule 210, whether the security vulnerability 32 should be mapped to or is associated with a first mitigation 152a. When the result of evaluating the rule 210a is yes, the deterministic evaluator 200 may return the mapping pair. When the result of evaluating the rule 210a is no, the deterministic evaluator 200 may evaluate a second rule 210b, and so on and so forth until the deterministic evaluator 200 has successfully mapped the security vulnerability 32 to a mitigation 152 or until the deterministic evaluator 200 has evaluated all of the applicable rules 210. In the latter scenario, the non- deterministic evaluator 300 may then proceed.

The deterministic approach may include determining that an identifier associated with the security vulnerability 32 is part of a signature associated with the networked device 30. The identifier may be a code, a name, a number, a symbol, or any other representation of the security vulnerability 32. The signature may be a pattern, a rule, a policy, a configuration, or any other representation of the networked device 30. The signature may indicate the type, the model, the version, the operating system, the software, the hardware, the firmware, the patch level, the settings, the permissions, or any other characteristics of the networked device 30. The signature may be stored in the data store 148 or in another storage device accessible by the risk controller 150.

The deterministic evaluator 200 may compare the identifier with the signature to determine if the security vulnerability 32 is protected by an existing mitigation control 152 on the networked device 30. The mitigation control 152 may be, for example, a firewall, an endpoint protection tool, a security update, a configuration change, a permission change, or any other action or measure that reduces or eliminates the exploitability of the security vulnerability 32. The mitigation control 152 may be applied to the networked device 30 by the user 12, automatically by the risk controller 150, by another software application or system, or by any other entity or mechanism. The deterministic evaluator 200 may determine that the mitigation control 152 is applied to the networked device 30 based on the signature or based on another indicator, such as a status, a flag, a log, a report, or a feedback.

Based on identifying the mitigation control 152, the deterministic evaluator 200, in some implementations, lowers the risk 170 associated with the security vulnerability 32. The risk 170 may be a measure of the likelihood and the impact of the security vulnerability 32 being exploited. The risk 170 may be expressed as a score, a level, a category, a color, or any other representation of the severity of the security vulnerability 32. The risk 170 may be associated with a ticket, incident report, etc., allowing for systematic tracking and management. When a risk 170 is identified, a ticket or incident report may be generated, and a user 12 or administrator may be notified through the system. This notification ensures that the relevant parties are aware of the risk 170 and can take appropriate action. Lowering the risk 170 associated with a ticket or incident report helps the user 12 prioritize their tasks, focusing on the most critical vulnerabilities 32 first and improving overall security posture.

The risk 170 may be stored in the data store 148 or in another storage device accessible by the risk controller 150. The deterministic evaluator 200 may lower the risk 170 by reducing the score, the level, the category, the color, or any other representation of the risk 170. The deterministic evaluator 200 may lower the risk 170 based on a predefined or dynamic rule, formula, algorithm, or model that takes into account various factors, such as the type, the nature, the source, the target, the exploitability, the impact, or the remediation of the security vulnerability 32 and the mitigation control 152.

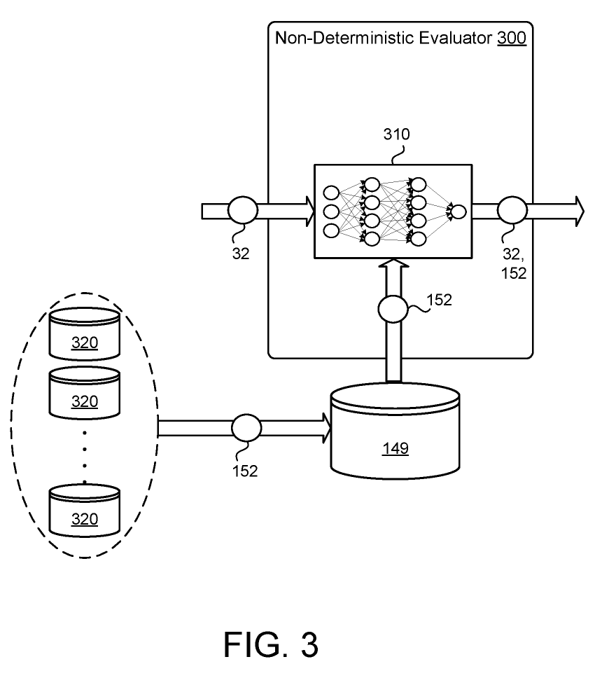

Referring now to FIG. 3, the non-deterministic evaluator 300 of the risk controller 150 is configured to identify a mitigation 152 for a security vulnerability 32 using a non-deterministic approach. The non-deterministic approach may include using a non-deterministic model 310, such as a large language model (LLM) or the like, to search one or more mitigation databases 149 that index any number of potential mitigations 152. The non-deterministic model 310 may be a machine learning model, a deep learning model, a neural network model, a natural language processing model, a natural language understanding model, a natural language generation model, a retrieval augmented generation model, or any other model that can analyze and synthesize information from various sources. The non-deterministic model 310 may be trained, updated, or fine-tuned using various data sets, such as the data store 148 or other data sources accessible by the risk controller 150.

The mitigation database(s) 149 may be a repository of information related to mitigations 152 for security vulnerabilities 32. The mitigation database 149 may include information from, for example, the MITRE ATT&CK framework and/or the National Vulnerability Database (NVD). The mitigation database 149 may provide procedures and mitigation techniques to prevent or reduce the harm caused by security vulnerabilities 32. The mitigation database 149 may be stored in the data store 148 or in another storage device accessible by the risk controller 150. The risk controller 150 may, periodically or based on some trigger, scrape or otherwise read data from one or more external databases 320, such as the MITRE database and/or the NVD database, to update or refresh the mitigation database 149. This ensures that the mitigation database 149 remains current with the latest security threats and mitigation strategies. The scraping or reading process may involve querying the external databases 320, retrieving relevant data, and integrating this data into the mitigation database 149. This process can be automated to occur at regular intervals or triggered by specific events, such as the detection of a new vulnerability 32 or an update to the external databases 320.

The non-deterministic evaluator 300 may query the non-deterministic model 310 with the security vulnerability 32 and pass the summary and the common weakness enumeration (CWE) associated with the security vulnerability 32 to the non-deterministic model 310. The summary may be a brief description of the security vulnerability 32, such as its name, its type, its nature, its source, its target, its exploitability, or its impact. The CWE may be a list of software weaknesses that can lead to security vulnerabilities 32. The non-deterministic evaluator 300, in some implementations, obtains the summary and the CWE from the data store 148 or from another data source accessible by the risk controller 150.

Retrieval augmented generation is a technique that combines generative and retrieval-based methods to produce natural language responses or solutions. In some implementations, the non-deterministic model 310 uses retrieval augmented generation to identify the mitigation 152 for a security vulnerability 32. The non-deterministic model 310 may use a generative component to generate a query or a prompt based on the summary and the CWE of the second security vulnerability 32. The query or the prompt may be a natural language expression that captures the essence or the context of the second security vulnerability 32.

The non-deterministic model 310 may use a retrieval component to search the mitigation database 149 for relevant or applicable information based on the query or the prompt. The retrieval component may use various techniques, such as keyword matching, semantic similarity, relevance ranking, or query expansion, to retrieve one or more potential mitigations 152 from the mitigation database 149. The retrieval component may also use various criteria, such as the type, the nature, the source, the target, the exploitability, the impact, or the remediation of the second security vulnerability 32 and the potential mitigations 152, to filter or sort the retrieved mitigations 152.

The non-deterministic model 310 may use a generative component to synthesize the retrieved mitigations 152 and produce a natural language response or solution that identifies the second mitigation 152 for the second security vulnerability 32. The generative component may use various techniques, such as neural networks, transformers, attention mechanisms, or language models, to generate the response or the solution. The generative component may also use various criteria, such as the coherence, the fluency, the accuracy, or the effectiveness of the response or the solution, to evaluate or refine the response or the solution.

The non-deterministic evaluator 300 may receive, from the non-deterministic model 310, a mitigation 152 for the security vulnerability 32. The mitigation 152 is any procedure or technique that can prevent or reduce the harm caused by the security vulnerability 32. The mitigation 152 may be based on the information from the mitigation database 149 that is relevant or applicable to the security vulnerability 32. In some examples, the non-deterministic evaluator 300 determines that the mitigation 152 is applied to the networked device 30 based on the signature or based on another indicator, such as a status, a flag, a log, a report, or feedback.

In some implementations, based on identifying the mitigation 152, the non- deterministic evaluator 300 lowers or otherwise adjusts the risk 170 (i.e., the risk level or threat level) associated with the security vulnerability 32. The risk 170 may be a measure of the likelihood and the impact of the security vulnerability 32 being exploited. The risk 170 may be expressed as a score, a level, a category, a color, or any other representation of the severity of the security vulnerability 32. The risk 170 may be stored in the data store 148 or in another storage device accessible by the risk controller 150. The non- deterministic evaluator 300 may lower the risk 170 by reducing the score, the level, the category, the color, or any other representation of the risk 170. Optionally, the non- deterministic evaluator 300 lowers the risk 170 based on a predefined or dynamic rule, formula, algorithm, or model that takes into account various factors, such as the type, the nature, the source, the target, the exploitability, the impact, or the remediation of the security vulnerability 32 and the mitigation 152.

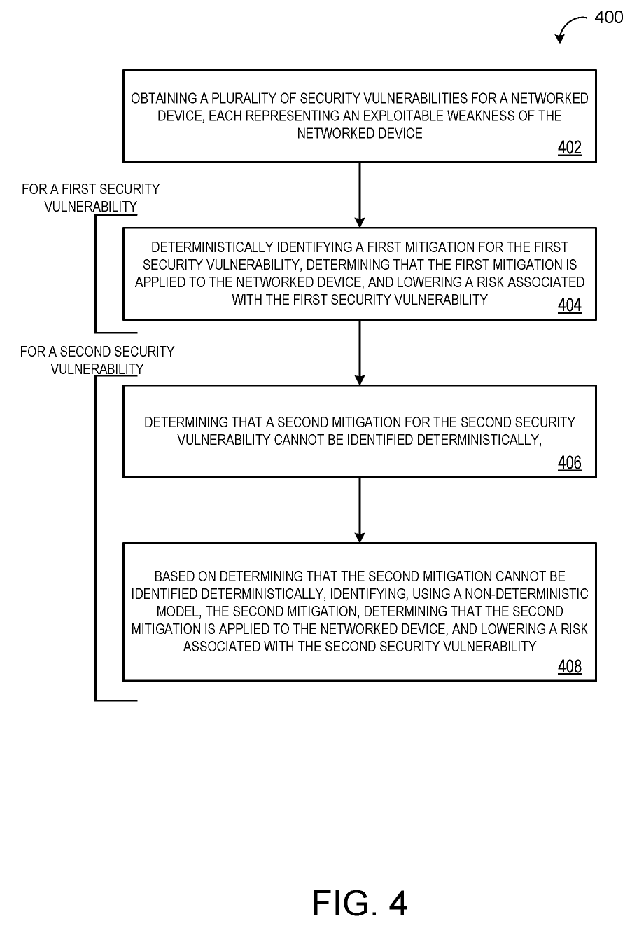

FIG. 4 is a flowchart of an example arrangement of operations for a method 400 for mitigating security vulnerabilities 32. The method 400, at operation 402, includes obtaining a plurality of security vulnerabilities 32 for a networked device 30. Each security vulnerability 32 represents an exploitable weakness of the networked device 30. The method 400, at operation 404, includes, for a first security vulnerability 32 of the plurality of security vulnerabilities 32, deterministically identifying a first mitigation 152 for the first security vulnerability 32. Based on identifying the first mitigation 152, the method 400 includes determining that the first mitigation 152 is applied to the networked device 30 and, based on determining that the first mitigation 152 is applied to the networked device 30, lowering a risk 170 associated with the first security vulnerability 32. The method 400, at operation 406, includes, for a second security vulnerability 32 of the plurality of security vulnerabilities 32, determining that a second mitigation 152 for the second security vulnerability 32 cannot be identified deterministically. The method 400, at operation 408, includes, based on determining that the second mitigation 152 cannot be identified deterministically, identifying, using a non-deterministic model 310, the second mitigation 152, determining that the second mitigation 152 is applied to the networked device 30, and lowering a risk 170 associated with the second security vulnerability 32.

Thus, the method leverages a non-deterministic model (e.g., a large language model) to assist in mapping vulnerabilities to mitigation techniques when deterministic methods are insufficient. Because the deterministic approach tends to be less computationally expensive, this allows the method to attempt to first map a mitigation to a security vulnerability using a more efficient approach before relying on a more powerful and subsequently more expensive approach (i.e., the non-deterministic approach). Moreover, the method enhances the prioritization of tickets by reducing the risk score of vulnerabilities that are mitigated by existing controls. This allows a vulnerability response system to focus resources on the most critical vulnerabilities, reducing risk and improving overall security posture.

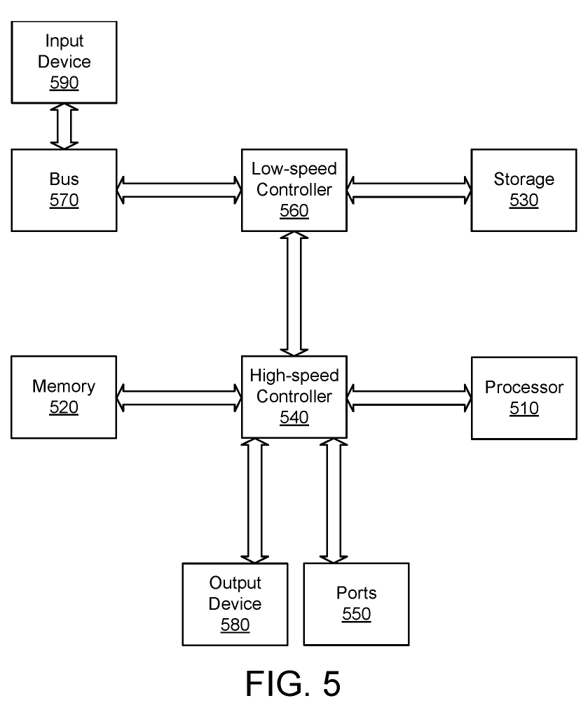

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM) / programmable read-only memory (PROM) / erasable programmable read-only memory (EPROM) / electronically erasable programmable read- only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non- transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth- intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term "non-transitory computer-readable medium" refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term "non-transitory computer- readable signal" refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an "application," an "app," a "program," or a "service." Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining a plurality of security vulnerabilities for a networked device, each security vulnerability of the plurality of security vulnerabilities representing an exploitable weakness of the networked device;
for a first security vulnerability of the plurality of security vulnerabilities:
deterministically identifying a first mitigation for the first security vulnerability;
based on identifying the first mitigation, determining that the first mitigation is applied to the networked device; and
based on determining that the first mitigation is applied to the networked device, lowering a risk associated with the first security vulnerability; and
for a second security vulnerability of the plurality of security vulnerabilities:
determining that a second mitigation for the second security vulnerability cannot be identified deterministically;
based on determining that the second mitigation cannot be identified deterministically, identifying, using a non-deterministic model, the second mitigation;
based on identifying the second mitigation, determining that the second mitigation is applied to the networked device; and
based on determining that the second mitigation is applied to the networked device, lowering a risk associated with the second security vulnerability.

2. The method of claim 1, further comprising, for a third security vulnerability of the plurality of security vulnerabilities:
identifying deterministically a third mitigation for the third security vulnerability;
based on identifying the third mitigation, determining that the third mitigation is not applied to the networked device; and
based on determining that the third mitigation is not applied to the networked device, maintaining or increasing a risk associated with the third security vulnerability.

3. The method of claim 1, further comprising, for a third security vulnerability of the plurality of security vulnerabilities:
identifying deterministically a third mitigation for the third security vulnerability;
based on identifying the third mitigation, determining that the third mitigation is not applied to the networked device; and
based on determining that the third mitigation is not applied to the networked device, automatically applying the third mitigation to the networked device.

4. The method of claim 1, further comprising, for a third security vulnerability of the plurality of security vulnerabilities:
determining that a third mitigation for the third security vulnerability cannot be identified deterministically;
based on determining that the third mitigation cannot be identified deterministically, identifying, using the non-deterministic model, the third mitigation;
based on identifying the third mitigation, determining that the third mitigation is not applied to the networked device; and
based on determining that the third mitigation is not applied to the networked device, maintaining or increasing a risk associated with the third security vulnerability.

5. The method of claim 1, further comprising, for a third security vulnerability of the plurality of security vulnerabilities:
determining that a third mitigation for the third security vulnerability cannot be identified deterministically;
based on determining that the third mitigation cannot be identified deterministically, identifying, using the non-deterministic model, the third mitigation;
based on identifying the third mitigation, determining that the third mitigation is not applied to the networked device; and
based on determining that the third mitigation is not applied to the networked device, automatically applying the third mitigation to the networked device.

6. The method of claim 1, wherein the networked device comprises one of an endpoint or a firewall.

7. The method of claim 1, wherein identifying deterministically the first mitigation for the first security vulnerability comprises determining that an identifier associated with the first security vulnerability is part of a signature associated with the networked device.

8. The method of claim 1, wherein the non-deterministic model comprises a large language model.

9. The method of claim 1, wherein identifying, using the non-deterministic model, the second mitigation comprises searching, using retrieval augmented generation, a mitigation database that indexes a plurality of potential mitigations.

10. The method of claim 1, further comprising, filtering the plurality of security vulnerabilities based on the risk associated with each security vulnerability.

11. A system comprising:
data processing hardware; and
memory hardware in communication with the data processing hardware, the memory hardware storing instructions that when executed on the data processing hardware cause the data processing hardware to perform operations comprising:
obtaining a plurality of security vulnerabilities for a networked device, each security vulnerability of the plurality of security vulnerabilities representing an exploitable weakness of the networked device;
for a first security vulnerability of the plurality of security vulnerabilities:
deterministically identifying a first mitigation for the first security vulnerability;
based on identifying the first mitigation, determining that the first mitigation is applied to the networked device; and
based on determining that the first mitigation is applied to the networked device, lowering a risk associated with the first security vulnerability; and
for a second security vulnerability of the plurality of security vulnerabilities:
determining that a second mitigation for the second security vulnerability cannot be identified deterministically;
based on determining that the second mitigation cannot be identified deterministically, identifying, using a non-deterministic model, the second mitigation;
based on identifying the second mitigation, determining that the second mitigation is applied to the networked device; and
based on determining that the second mitigation is applied to the networked device, lowering a risk associated with the second security vulnerability.

12. The system of claim 11, further comprising, for a third security vulnerability of the plurality of security vulnerabilities:
identifying deterministically a third mitigation for the third security vulnerability;
based on identifying the third mitigation, determining that the third mitigation is not applied to the networked device; and
based on determining that the third mitigation is not applied to the networked device, maintaining or increasing a risk associated with the third security vulnerability.

13. The system of claim 11, further comprising, for a third security vulnerability of the plurality of security vulnerabilities:
identifying deterministically a third mitigation for the third security vulnerability;
based on identifying the third mitigation, determining that the third mitigation is not applied to the networked device; and
based on determining that the third mitigation is not applied to the networked device, automatically applying the third mitigation to the networked device.

14. The system of claim 11, further comprising, for a third security vulnerability of the plurality of security vulnerabilities:
determining that a third mitigation for the third security vulnerability cannot be identified deterministically;
based on determining that the third mitigation cannot be identified deterministically, identifying, using the non-deterministic model, the third mitigation;
based on identifying the third mitigation, determining that the third mitigation is not applied to the networked device; and
based on determining that the third mitigation is not applied to the networked device, maintaining or increasing a risk associated with the third security vulnerability.

15. The system of claim 11, further comprising, for a third security vulnerability of the plurality of security vulnerabilities:
determining that a third mitigation for the third security vulnerability cannot be identified deterministically;
based on determining that the third mitigation cannot be identified deterministically, identifying, using the non-deterministic model, the third mitigation;
based on identifying the third mitigation, determining that the third mitigation is not applied to the networked device; and
based on determining that the third mitigation is not applied to the networked device, automatically applying the third mitigation to the networked device.

16. The system of claim 11, wherein the networked device comprises one of an endpoint or a firewall.

17. The system of claim 11, wherein identifying deterministically the first mitigation for the first security vulnerability comprises determining that an identifier associated with the first security vulnerability is part of a signature associated with the networked device.

18. The system of claim 11, wherein the non-deterministic model comprises a large language model.

19. The system of claim 11, wherein identifying, using the non-deterministic model, the second mitigation comprises searching, using retrieval augmented generation, a mitigation database that indexes a plurality of potential mitigations.

20. A computer-readable medium having instructions that, when executed by data processing hardware, causes the data processing hardware to perform operations comprising:
obtaining a plurality of security vulnerabilities for a networked device, each security vulnerability of the plurality of security vulnerabilities representing an exploitable weakness of the networked device;
for a first security vulnerability of the plurality of security vulnerabilities:
deterministically identifying a first mitigation for the first security vulnerability;
based on identifying the first mitigation, determining that the first mitigation is applied to the networked device; and
based on determining that the first mitigation is applied to the networked device, lowering a risk associated with the first security vulnerability; and
for a second security vulnerability of the plurality of security vulnerabilities:
determining that a second mitigation for the second security vulnerability cannot be identified deterministically;
based on determining that the second mitigation cannot be identified deterministically, identifying, using a non-deterministic model, the second mitigation;
based on identifying the second mitigation, determining that the second mitigation is applied to the networked device; and
based on determining that the second mitigation is applied to the networked device, lowering a risk associated with the second security vulnerability.
